(19) United States
(12) Patent Application Publication
(10) Pub. No.: US 2008/0191013 A1
(43) Pub. Date: Aug. 14, 2008

(54) System and Method for Intelligent Administration and Documentation of Drug Usage

(76) Inventor: Aldo Liberatore, London (CA)

Correspondence Address: BLAKE, CASSELS & GRAYDON LLP, BOX 25, COMMERCE COURT WEST, 199 BAY STREET, SUITE 2800, TORONTO, ON, M5L 1A9, omitted

(21) Appl. No.: 12/030,574

(22) Filed: Feb. 13, 2008

Related U.S. Application Data
(60) Provisional application No. 60/889,670, filed on Feb. 13, 2007.

(51) Int. Cl. G06F 19/00

(52) U.S. Cl. 235/385

(57) ABSTRACT

A system and method are provided for automated and precise administration and documentation of medical drugs. An identification mechanism such as barcodes or RFID technology is incorporated into a syringe that can be loaded into a syringe gun having an appropriate reader. The syringe gun includes or communicates with a control system that can store or communicate with a database comprising drug, patient and inventory information. The information can be used by the control system to control the administration of the drug, provide suitable safeguards based on the nature of the drug and the patient, and to update inventory and initiate billing as required.

This application claims priority from U.S. Application No. 60/889,670 filed on Feb. 13, 2007, the contents of which are incorporated herein by reference.

### FIELD OF THE INVENTION

The following relates to the administration and documentation of drug usage.

### DESCRIPTION OF THE PRIOR ART

The use of medical drugs in the health care industry is intended to be strictly controlled and monitored due to the importance of the appropriateness of the drugs being administered to a given patient. Incorrectly prescribed and/or administered drugs can have significant repercussions. Similarly, inventories require monitoring to ensure that sufficient stock is available to health care facilities and to ensure that expired drugs are not kept in circulation.

Such controls can be difficult to manage and track by health care professionals, especially where healthcare facilities are networked and share resources and patients.

It is therefore an object of the following to provide a system and method for obviating or mitigating the above-noted difficulties.

### SUMMARY

In one aspect, a method for controlling administration of the contents of a receptacle is provided comprising providing a holder for holding the receptacle; the holder reading an identifier on the receptacle to obtain data pertaining to the contents; the holder determining the acceptability of the contents according to one or more criteria; and if the contents are deemed to be acceptable, administering the contents according to a predetermined dosage at a predetermined rate.

In one embodiment of the method, the identifier is provided by a barcode affixed to the receptacle and in another embodiment of the method, the identifier is provided by a radio frequency identification (RFID) tag included with the receptacle.

In another aspect, system for controlling administration of the contents of a receptacle is provided comprising a holder for holding the receptacle, the holder comprising a reader for reading an identifier on the receptacle to obtain data pertaining to the contents, and a control mechanism for administering the contents according to a predetermined dosage at a predetermined rate; and a controller for determining the acceptability of the contents according to one or more criteria and for permitting administration of the contents if they are deemed to be acceptable.

In one embodiment of the system, the identifier is provided by a barcode affixed to the receptacle, and in another embodiment of the system, the identifier is provided by a radio frequency identification (RFID) tag included with the receptacle.

### BRIEF DESCRIPTION OF THE DRAWINGS

An embodiment of the invention will now be described by way of example only with reference to the appended drawings wherein:

FIG. 1 is a plan view of a syringe comprising a barcode.

FIG. 2 is a plan view of a syringe comprising an embedded radio frequency identification (RFID) tag.

FIG. 3 is a perspective view of a portable syringe gun.

FIG. 4 is a perspective view of a portable syringe gun comprising a barcode reader.

FIG. 5 is a perspective view of a portable syringe gun comprising an RFID reader.

FIG. 6 is a perspective view of a syringe control system comprising the portable syringe gun shown in FIG. 3.

FIG. 7 is a flow chart illustrating a syringe read operation.

FIG. 8 is a flow chart illustrating a usage restriction check operation.

FIG. 9 is a flow chart illustrating an expiry date check operation.

FIG. 10 is a flow chart illustrating a final restriction check operation.

FIG. 11 is a flow chart illustrating a controlled syringe administration operation.

FIG. 12 is a flow chart illustrating a billing and print operation.

### DETAILED DESCRIPTION OF THE INVENTION

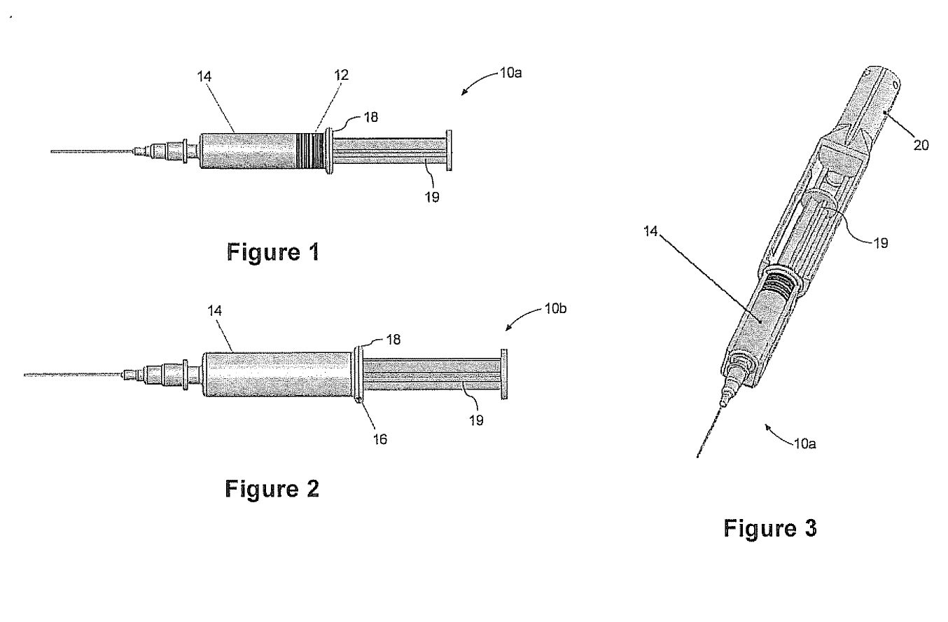

Referring now to the figures, in particular, FIG. 1, a syringe 10a in one embodiment comprises a barcode 12 affixed to the exterior of a syringe barrel 14. The barcode 12 provides a serial number that may be referred to one or more descriptors and/or identifiers for the syringe 10a and its contents, owner etc. In one embodiment, the barcode 12 references a description of the drug or other contents of the syringe 10a, the manufacturer and location of the manufacturer, the data of manufacture, the expiration date of the contents, and the batch number. It will be appreciated that any other applicable information may be referenced to the serial number represented by the barcode 12. As such, the above noted information is for illustrative purposes only, and any combination of one or more of such identifying information may be associated with the syringe 10a and its corresponding serial number.

In another embodiment, shown in FIG. 2, rather than a barcode 12, a radio frequency identification (RFID) tag or transmitter 16 embedded in the flange 18 of the barrel 14 of a syringe 10b. It is well known that, in many applications, RFID technology can be beneficial when compared to using barcodes 12, as RFID technology provides an automatic identification and may be capable of storing additional data.

RFID technology relies on the storage and retrieval of data using the RFID tag 16, sometimes also referred to as an RFID transponder. An RFID tag 16 is an object that can be attached to or incorporated into a product or even a living being such as an animal for the purpose of identification using radio waves. There are chip-based RFD tags 16 that contain silicon chips and antennas and RFID tags 16 can be either passive or active.

Passive RFID tags 16 require no internal power source. The relatively small electrical current induced in the antenna by the incoming radio frequency signal provides enough power for the circuit in the tag 16 to power up and transmit a response. Often, passive tags 16 signal by backscattering the carrier signal from the reader and thus the antenna is designed to both collect power from the incoming signal and also to transmit the outbound backscatter signal. Without requiring an onboard power supply, passive REID tags 16 can be smaller and more cost effective to implement.

Active RFID tags 16 have their own internal power source which is used to power any circuit resident on the tag that generates an outgoing signal. Active tags 16 have been found to be more reliable than passive RFID tags 16 since active tags 16 can conduct a “session” with a reader. With an onboard power supply, an active RFID tag 16 can transmit a higher power signal which allows them to be more effective in areas where RF signals have trouble transmitting such as water, and at longer distances. The onboard power supply also requires more space and thus active RFID tags 16 are generally larger and more expensive than passive RFID tags 16. The syringe 10b may utilize either active or passive RFID technology depending on preference, cost constraints etc.

It will be appreciated that other identification mechanisms may also be used in place of a barcode 12 or REID tag 16, such as a printed label (not shown) that can be optically identified, a microchip with electrical contacts for connecting to a suitable reader, any other wireless transmission device, etc.

Hereinafter, a syringe may be generally referred to by numeral 10 (without suffix), whether it utilizes a barcode 12, REID tag 16 or other similar identification mechanism such as a printed label (not shown).

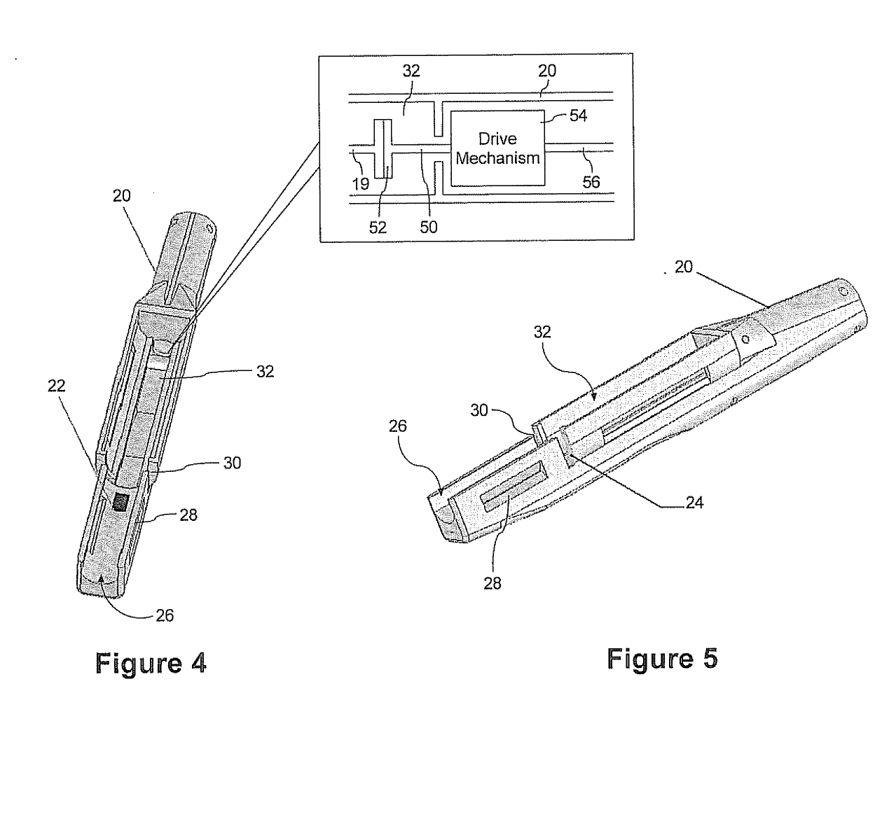

To retrieve information from, e.g. the barcodes 12 and RFID tags 16, a reader is included with the overall system. As shown in FIGS. 4 and 5, a syringe gun 20 may be used to retain and control the operation of the syringe 10. In one embodiment shown in FIG. 4, the gun 20 comprises a barcode reader 22, which may be implemented using an integrated charge coupled device (CCD) camera, a 2D imaging camera, and suitable light-source type technologies such as a laser etc. In another embodiment, shown in FIG. 5, the gun 20 comprises an RFID reader 24.

The nature of the RFID reader 24 typically depends on whether the RFID tag 16 is active or passive. As such, it will be appreciated that the RFID reader 24 may be configured for and adapted to suit the particular application. In one application, a signal is emitted from the REID reader 24, which then activates the RFID tag 16 so that the RFID reader 24 can read (and write if necessary) data to the RFID tag 16. When the RFID tag 16 passes through the electromagnetic zone created by the emission (i.e. when the syringe 10b is “cradled” or retained by the gun 20), the RFID tag 16 detects the reader's activation signal. The RFID reader 24 may then decode the data encoded in the tag's memory and the data may be passed to supporting infrastructure for its particular use.

The syringe gun 20 is designed to both retain the syringe and to administer the contents of the syringe 20 in a controlled and precise fashion as shown in FIG. 3. For the embodiments shown in FIGS. 4 and 5, the gun 20 is configured to provide a syringe barrel holder 26, which comprises a pair of protrusions 28 for frictionally retaining the syringe 10, and a slot 30 for receiving the syringe flange 18. This enables the syringe 10 to be held in a consistent position such that a piston 50 and pusher 52 may move within a plunger barrel 32.

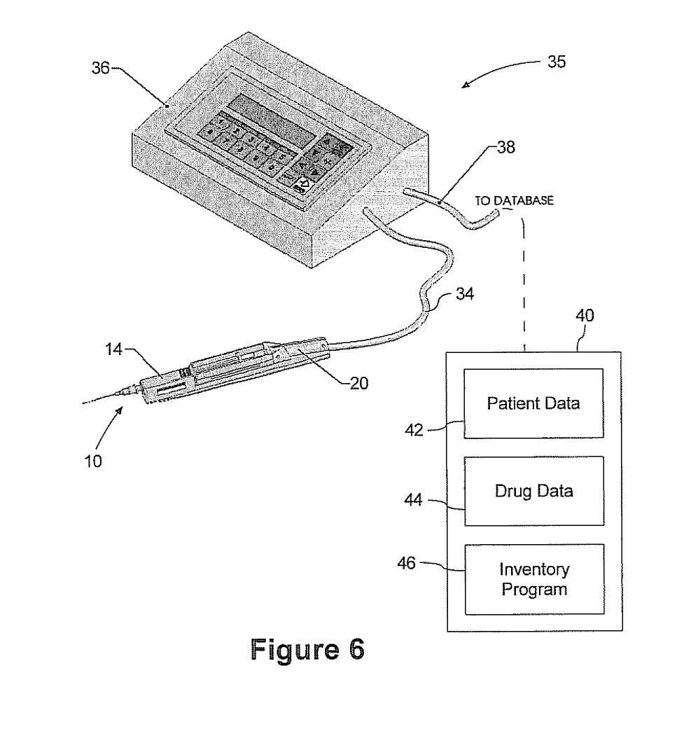

The plunger barrel 32 accommodates the syringe plunger 19 as seen in FIG. 3 and, as seen in FIG. 4, houses the piston 50 and pusher 52 that bears against the plunger 19 in a controlled manner. Movement of the piston 50 is provided by a drive mechanism 54 contained in the gun 20, which is controlled by a command signal 56. The control signal 56 may be provided by an internal processor (not shown), or may be controlled externally through a data connection 34 to a control system 35, which is shown in FIG. 6.

As can be appreciated from FIGS. 3 to 5, the syringe gun 20 is designed to provide the feel and comfort of a pen or other slim handheld device or tool, providing greater comfort and control for the operator when administering the contents of the syringe 10. In this way, the gun 20 may be handled in a manner similar to handling the syringe 10 by itself but with the added controllability and communication capabilities of the gun 20 and control system 36 (whether internal or external). Where connection 34 is wireless or the control system 36 is internal, a completely portable gun 20 may be provided. It will be appreciated that for portable, cordless/wireless embodiments, a suitable power supply such as a battery would be included in the gun 20.

Turning now to FIG. 6, the control system 35 may be implemented as shown with an external console 36, or may be included in the gun 20 to provide a completely handheld system. Also, where an external console 36 is used, the data connection 34 may instead be wireless to provide a cordless gun 20. The control system 35 is in this embodiment connected to an external database 40 or program via data connection 38. It will be appreciated that an internal database 40 may instead be used. An external data connection 38 is however particularly beneficial where the gun 20 is to communicate with and take advantage of information provided by an existing hospital network or patient database system that is separate from the syringe control system 36. The data connection 38 may be wireline, wireless depending on the supporting infrastructure and network.

In this embodiment, the control system 36 is capable of connecting to patient data 42, drug data 44 (pertaining to the syringe 10) and an inventory program 46 for tracking and monitoring syringe use, through connection 38 and in turn by accessing and communicating with database/program/network 40.

In another embodiment, and where capabilities permit, the RFID tags 16 can store additional data pertaining to the syringe 10 (i.e. in addition to a serial or identification number) thereby eliminating the need to store drug data 44 in the database 40. It will be appreciated that such an embodiment can be implemented utilizing RFID tags 16 with the appropriate storage capabilities. Similarly, where active RFID tags 16 are used, the write capabilities enable the control system 35 to record events such as time stamps directly on the tag 16, or overwrite the tag information to prevent subsequent use of the same syringe 10 (i.e. unauthorized recycling of a used syringe 10).

The control system 35 may be used to assist the operator with the administration of the syringe's contents by either responding to the operator's manual requests semi-automatically, or by executing a pre-programmed sequence of instructions in a completely automated fashion.

An example of semi-automatic control would be to have the syringe gun 20 respond to the operator pressing on an “inject” pushbutton on the console 36 (or gun 20 if appropriate) and administering the syringe's contents at a prescribed rate of delivery (e.g. 0.02 milliliters per second). Upon release of the “inject” pushbutton, operation of the syringe gun 20 would then stop.

An example of automatic control would be to, upon selecting an appropriate input such as a pushbutton, have the control system 35 execute the following sequence of operations: delay start for a predetermined amount of time (e.g. 3 seconds), inject a prescribed amount of syringe content at a prescribed rate (e.g. 1.1 milliliters over 45 seconds), stop for a predetermined amount time (e.g. 2 seconds), and aspirate a prescribed amount at a prescribed rate (e.g. 0.1 milliliters over 3 seconds).

It has been recognized that combining the identification features of the syringe 10 (e.g. using barcode 12, RFID tags 16 etc.) and the communication and control capabilities of the control system 35′ various benefits can be achieved. Such benefits comprise confirming the contents of the syringe 10, and linking the information provided by the syringe 10 to patient data 42, inventory levels 46 and other drug-related data 44. In addition, the handheld gun 20 provides greater comfort and feel for the operator, and the linkage to the control system 35 enables actions to be recorded, time stamped, audited and acknowledgements and alarms annunciated to the operator.

Use of the gun 20 may also enable stricter control over the administration of the syringe contents by only enabling operation of the gun once necessary acknowledgements have been received. As such, other security features can be included into the syringe 10 such as data security in the RFID tag 16.

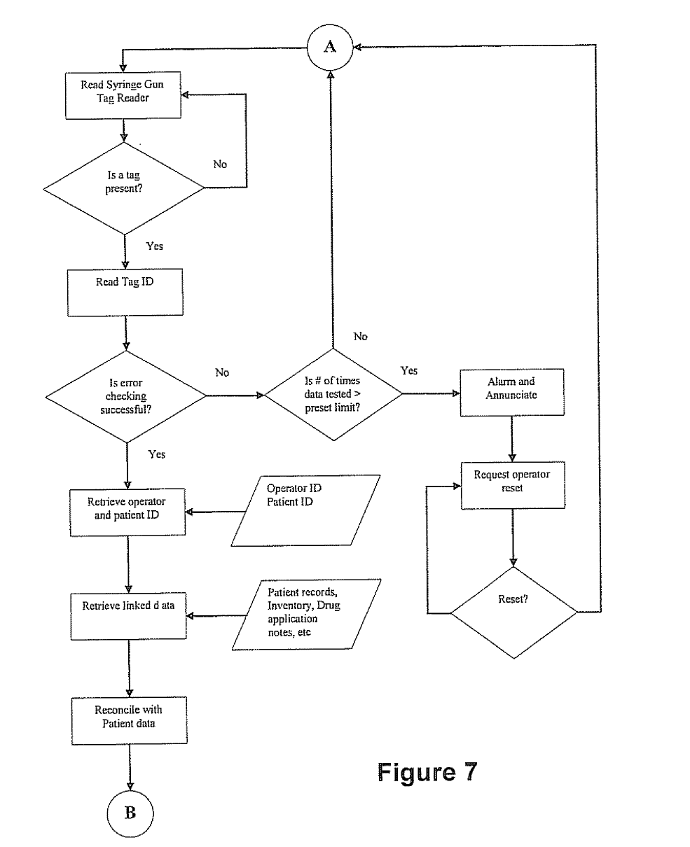

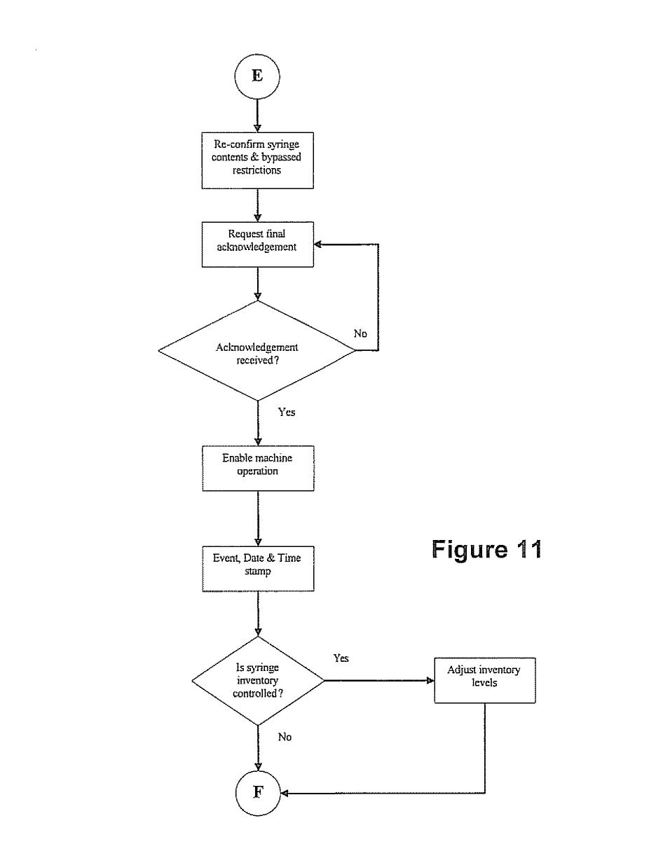

An example of the operation of the control system 35 and syringe gun 20 for administering the contents of a syringe 10 may now be described making reference to the flowcharts shown in FIGS. 7-12.

Turning first to FIG. 7, the operator first loads a syringe 10 into the syringe gun 20 and turns on the console 36 (or turns on the gun 20 if control system 35 is internal). Either automatically, or upon receiving an appropriate input, the control system 35 attempts to read the syringe 10 using, in the embodiments shown, the barcode reader 22 or REID reader 24. If a barcode 12 or RFID tag 16 cannot be detected, then the control system 35 will wait or idle until one can be detected. As such, a “sleep” mode may be incorporated during which the control system 35 waits until a syringe 10 is loaded before being fully operational. For the following example an RFID enabled syringe 10 (e.g. syringe 10b) and an RFID enabled syringe gun 20 are used. It will be appreciated that similar principles may apply to the use of barcode 12 enabled systems.

If an RFID tag 16 can be found, the control system 35 commands the syringe gun 20 to operate the RFID reader 24, e.g. by transmitting an RF wave to stimulate a response from the RFID tag 16, which in turn transmits information pertaining to the syringe 10 such as a serial number. Preferably, an error checking step is performed which verifies the data provided by the tag 16, e.g. to determine if the data is even readable or valid. If the error checking step is not successful, the control system 35 then references an internal counter that keeps track of the number of times the data on the RFID tag 16 has been tested. If this number is greater than a preset limit, an alarm is then displayed on the console 36 and/or annunciated to the operator to request that the operator reset the console 36. This alarm should be displayed until the console has been reset, whereupon the control system 35 then waits for, or proceeds to execute another read operation.

If the number of times the data has been tested is less than the predetermined number of allowable reads, then the control system 35 may attempt to read the syringe 10 again, which can be done if the syringe 10 remains cradled in the gun 20.

If the error checking is successful, the control system 35 may then establish a link to the database 40 to obtain a patient identifier from the patient data 42 and/or an operator identifier. The operator identifier may be requested upon powering up the control system 35 and be stored in the console 36, or may be entered each time a drug is administered. Other patient data may also be retrieved at this time and stored in memory for use in administering the contents of the syringe 10.

In addition to associated patient data 42, drug data 44 and inventory data from the inventory program 46 may also be retrieved. This enables the control system 35 to intelligently administer the drug and update patient records, inventory records and operator records. Using this data, the control system 35 first reconciles the drug data 44 by comparing information associated with the syringe 10 with the appropriate patient data 42. For example, there may be certain drugs which a particular patient cannot take due to an allergy and thus the control system 35 can determine whether or not the syringe 10 that has been loaded is either incorrect or otherwise inappropriate.

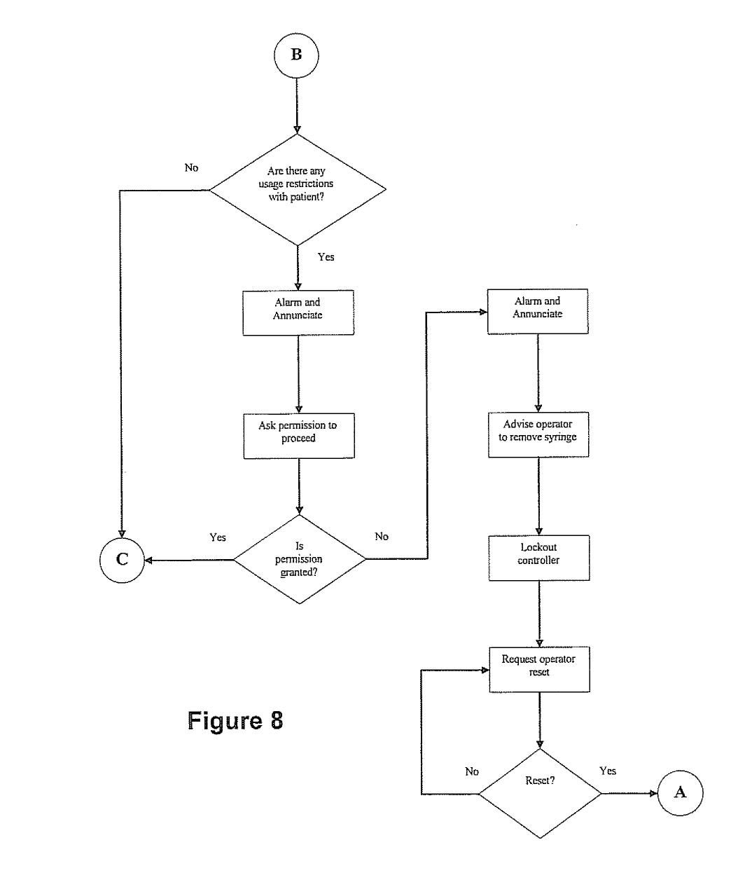

Turning now to FIG. 8, if it is determined that there is one or more restrictions with the patient, either based on the type of drug or their patient file, an alarm may be displayed and annunciated, whereupon the operator is asked permission to proceed. If permission is not granted, another alarm may be provided advising the operator to remove the syringe 10. This may occur where the control system 35 identifies a restriction and the operator confirms that the syringe 10 is incorrect. At this time, the drive mechanism 54 is preferably locked to avoid inadvertent administration of the restricted drug. The operator may then be requested to reset the console 36, and once this has been done, control is then returned to point A in FIG. 7 to enable the control system 35 to read another syringe 10.

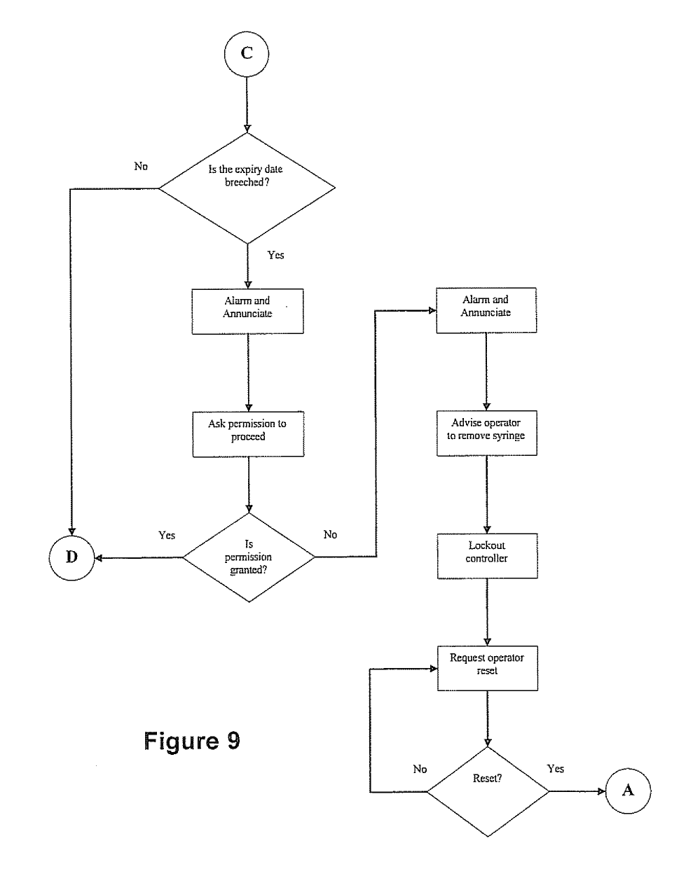

If at this stage there are no restrictions or there is a restriction and permission is granted, the expiry data for the drug is then determined using the drug data 44 as shown in FIG. 9. If the expiry data has been breeched, an alarm may be displayed and permission requested. If the operator does not grant permission (e.g. using an appropriate input on the console 36), another alarm may be displayed and annunciated and the operator advised to remove the syringe 10 from the syringe gun 20. The drive mechanism 54 is then preferably locked to prevent accidental administration. The operator may then be requested to reset the console 36 and another syringe 10 loaded and read as described above, if necessary.

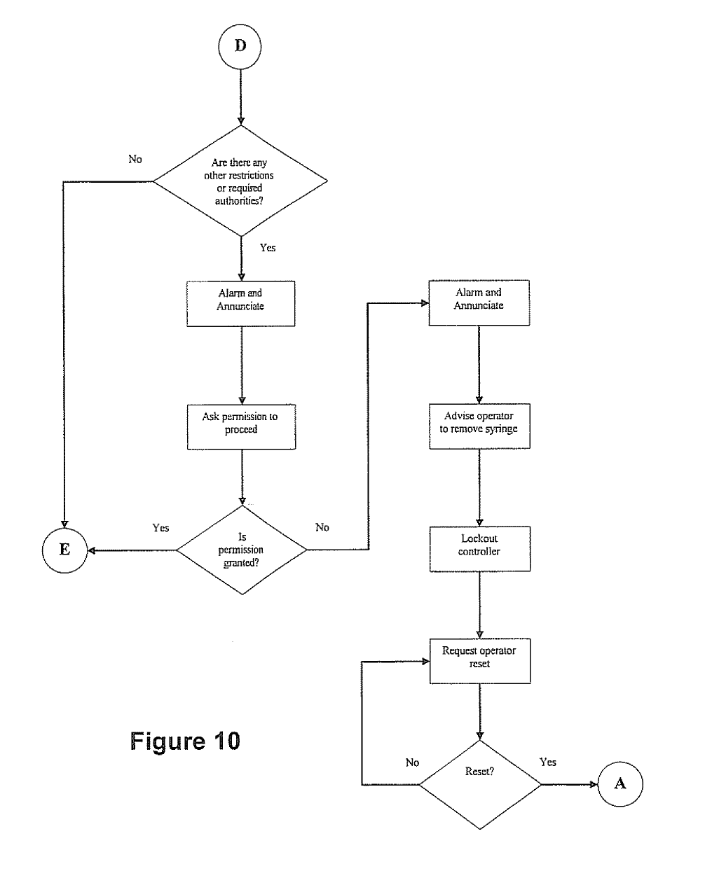

If the expiry date has not been breeched or if the expiry date has been breeched but permission is granted by the operator (e.g. expired but within an acceptable period beyond the expiration date), any other restrictions or required permissions are checked as shown in FIG. 10. If any of these restrictions is/are found, permission may be granted by the operator as above, and the appropriate alarms displayed and annunciated.

Once all restrictions and permissions have been cleared, i.e. the control system 35 has determined that the syringe 10 is suitable for administering to the patient; the syringe 10 is preferably re-read. In this embodiment, the RFID reader 24 stimulates the RFID tag 16 and reads the serial number to confirm the contents of the syringe 10. As a further precaution, the control system 35 may then ask the operator for a final acknowledgement, whereupon receipt of the acknowledgement clears the control system 35 to send appropriate command signals 36 to the drive mechanism 54 for administering a prescribed dose at a prescribed rate, either automatically or semi-automatically as discussed above.

It will be appreciated that the prescribed dosages and rates may be obtained from the database 40 and thus may differ for each syringe 10. In this way, the syringe gun 20 can be used to control any suitable syringe 10 that is capable of being used with the gun 20 and control system 35. It will also be appreciated that the control system 35 and gun 20 can be used manually upon receiving an appropriate override command. Preferably, overriding the control system 35 involves entering and/or confirming operator identification information and/or a password.

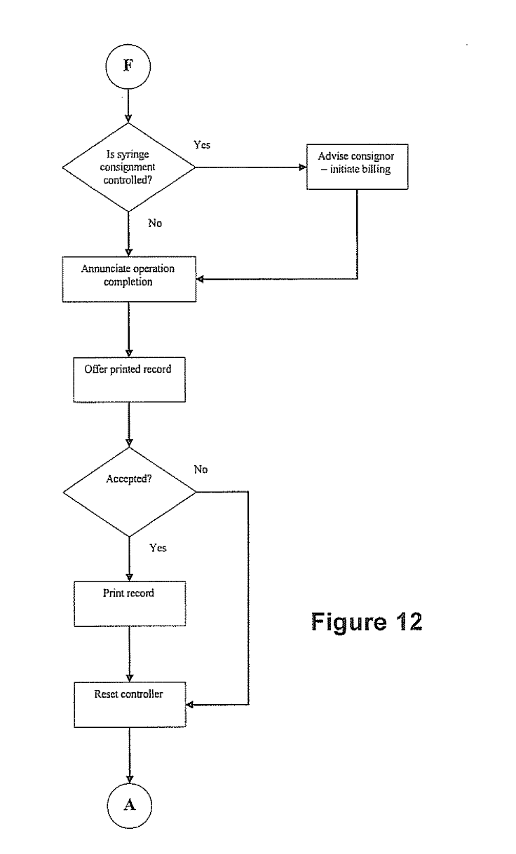

The control system 35 then records the use of the syringe 10 as an event, creates a data and time stamp, creates a new patient record, and creates a drug usage record. If the syringe 10 is inventory controlled (e.g. using inventory program 46), the inventory levels may be adjusted by communicating with the database 40. If the inventory levels are not being controlled, billing and record keeping may then be performed as shown in FIG. 12.

In some cases, the syringe 10 may be part of a consignment billing structure where the control system 35 then advises the consignor that a syringe 10 has been used and thus billing can commence. This may be done by creating an inventory log to send to the consignor at a later time, or by sending an electronic communication such as an email where possible in “real time”.

Once the appropriate records have been created and the billing operation completed (if necessary), the console 36 preferably annunciates to the operator that the syringe administration is complete. A printout may be offered to the operator via the console 36 (e.g. using a suitable printing device), and if accepted, a record or report may then be printed. At this time, the patient records can be updated by the control system 35 sending the updated records to the database 40. It will be appreciated that where the control system 35 communicates and is compatible with an external hospital network, certain communication protocols may be required to effect such communication.

Upon completion of the administration of the contents of the syringe 10, the operator is then instructed to reset the console 36 to enable another syringe 10 to be loaded and read.

It can therefore be seen that the identification capabilities included with the design of the syringe 10 (e.g. barcodes 12 and REID tags 16), in combination with the communication and control capabilities of the control system 35, enable more accurate and complete error checking, inventory control, patient and drug record keeping and billing capabilities. These capabilities are further benefited by the comfort and control provided by the shape and design of syringe gun 20. Moreover, the gun 20 enables many types of syringes to be loaded and may communicate with external sources to provide specific control operations for specific syringes 10 and contents thereof. It will be appreciated that the syringe gun 20 and control system 35 may be configured to read and process more than one type of identifier such as both barcode 12 and RFID tags 16 etc.

It will also be appreciated that any one or more combination of features shown in FIG. 6 may be included directly in the syringe gun 20 to provide various levels of portability. Similarly, both wireline or wireless technologies and protocols may be accommodated where permitted and as appropriate, depending on the nature of the environment and application. The above principles are also suitable in other fields such as dentistry and should not be limited to medical drug applications as exemplified herein. Similarly, although the above examples refer to administration of a drug from a syringe, the above principles are applicable to the administration of the contents of other receptacles.

Although the invention has been described with reference to certain specific embodiments, various modifications thereof will be apparent to those skilled in the art without departing from the spirit and scope of the invention as outlined in the claims appended hereto.

1. A method for controlling administration of the contents of a receptacle comprising:
providing a holder for said receptacle;
said holder reading an identifier on said receptacle to obtain data pertaining to said contents;
said holder determining the acceptability of said contents according to one or more criteria; and
if said contents are deemed to be acceptable, administering said contents according to a predetermined dosage at a predetermined rate.

2. The method according to claim 1 wherein said identifier is provided by any one or more of a barcode affixed to said receptacle, a radio frequency identification (RFID) tag included with said receptacle, a printed label affixed to said receptacle and a microchip having electrical contacts for connecting to a reader.

3. The method according to claim 1 wherein said receptacle is a syringe and said holder is a syringe barrel configured to retain said syringe, said syringe barrel comprising a piston and pusher for operating on said syringe to control administration of said contents.

4. The method according to claim 1 wherein said contents are administered by operating on said receptacle using a control system.

5. The method according to claim 4 wherein said control system operates a drive mechanism included in said holder for said operating on said receptacle.

6. The method according to claim 4 wherein said control system is external to said holder.

7. The method according to claim 4 wherein said control system resides in said holder.

8. The method according to claim 4 wherein said control system is connectable to a database comprising information associated with said receptacle.

9. The method according to claim 8 wherein said database comprises an inventory program.

10. The method according to claim 9 wherein said receptacle is a syringe and said holder is a syringe barrel configured to retain said syringe, said database comprising patient information used to determine the acceptability of said contents.

11. A system for controlling administration of the contents of a receptacle comprising:
a holder for holding said receptacle, said holder comprising a reader for reading an identifier on said receptacle to obtain data pertaining to said contents, and a control mechanism for administering said contents according to a predetermined dosage at a predetermined rate; and
a controller for determining the acceptability of said contents according to one or more criteria and for permitting administration of said contents if said contents are deemed to be acceptable.

12. The system according to claim 11 wherein said identifier is provided by any one or more of a barcode affixed to said receptacle, a radio frequency identification (RFID) tag included with said receptacle, a printed label affixed to said receptacle and a microchip having electrical contacts for connecting to a reader.

13. The system according to claim 11 wherein said receptacle is a syringe and said holder is a syringe barrel configured to retain said syringe, said syringe barrel comprising a piston and pusher for operating on said syringe to control administration of said contents.

14. The system according to claim 11 wherein said controller operates a drive mechanism included in said holder for said operating on said receptacle.

15. The system according to claim 11 wherein said controller is external to said holder.

16. The system according to claim 11 wherein said controller resides in said holder.

17. The system according to claim 11 wherein said controller is connectable to a database comprising information associated with said receptacle.

18. The system according to claim 17 wherein said database comprises an inventory program.

19. The system according to claim 18 wherein said receptacle is a syringe and said holder is a syringe barrel configured to retain said syringe, said database comprising patient information used to determine the acceptability of said contents.

20. The system according to claim 11 comprising one or more alarms for indicating said acceptability.
